(19) United States
(12) Patent Application Publication
(10) Pub. No.: US 2017/0175543 A1
(43) Pub. Date: Jun. 22, 2017

(54) COOLING CIRCUIT FOR A MULTI-WALL BLADE

(71) Applicant: General Electric Company, Schenectady, NY (US)

(72) Inventors: David Wayne Weber, Simpsonville, SC (US); Fred Thomas Willett, JR., Burnt Hills, NY (US)

(21) Appl. No.: 14/977,152

(22) Filed: Dec. 21, 2015

(51) Int. Cl. F01D 5/18; F01D 5/14

(52) U.S. Cl. CPC F01D 5/187; F01D 5/147; F05D 2220/30; F05D 2260/2214

(57) ABSTRACT

A turbine blade cooling system according to an embodiment includes: a first arcuate turn for redirecting a first flow of gas flowing through a first channel of a turbine blade into a central plenum of the turbine blade; and a second arcuate turn for redirecting a second flow of gas flowing through a second channel of the turbine blade into the central plenum of the turbine blade, wherein the first and second arcuate turns reduce impingement of the first flow of gas and the second flow of gas in the central plenum of the turbine blade.

### CROSS-REFERENCE TO RELATED APPLICATIONS

This application is related to co-pending U.S. application Ser. No. ______, GE docket numbers 282167-1, 282169-1, 282171-1, 283464-1, 283467-1, 283463-1, 283462-1, and 284160-1, all filed on ______.

### BACKGROUND OF THE INVENTION

The disclosure relates generally to turbine systems, and more particularly, to reducing pressure loss in a multi-wall turbine blade cooling circuit.

Gas turbine systems are one example of turbomachines widely utilized in fields such as power generation. A conventional gas turbine system includes a compressor section, a combustor section, and a turbine section. During operation of the gas turbine system, various components in the system, such as turbine blades, are subjected to high temperature flows, which can cause the components to fail. Since higher temperature flows generally result in increased performance, efficiency, and power output of the gas turbine system, it is advantageous to cool the components that are subjected to high temperature flows to allow the gas turbine system to operate at increased temperatures.

Turbine blades of a gas turbine system typically contain an intricate maze of internal cooling channels. The cooling channels receive air from the compressor of the gas turbine system and pass the air through the internal cooling channels to cool the turbine blades. The feed pressure of the air passed through the cooling channels is generally at a premium, since the air is bled off of the compressor. To this extent, it is useful to provide cooling channel that reduce non-recoverable pressure loss; as pressure losses increase, a higher feed pressure is required to maintain an adequate gas-path pressure margin (back-flow margin). Higher feed pressures result in higher leakages in the secondary flow circuits (e.g., in rotors) and higher feed temperatures.

### BRIEF DESCRIPTION OF THE INVENTION

A first aspect of the disclosure provides a turbine blade cooling system, including: a first arcuate turn for redirecting a first flow of gas flowing through a first channel of a turbine blade into a central plenum of the turbine blade; and a second arcuate turn for redirecting a second flow of gas flowing through a second channel of the turbine blade into the central plenum of the turbine blade, wherein the first and second arcuate turns reduce impingement of the first flow of gas and the second flow of gas in the central plenum of the turbine blade.

A second aspect of the disclosure provides turbine blade, including: a cooling system, the cooling system including: a cooling system disposed within the turbine blade, the cooling system including: a first arcuate turn for redirecting a first flow of gas flowing through a first channel of the turbine blade into a central plenum of the turbine blade; and a second arcuate turn for redirecting a second flow of gas flowing through a second channel of the turbine blade into the central plenum of the turbine blade; wherein the first and second arcuate turns reduce impingement of the first flow of gas and the second flow of gas in the central plenum of the turbine blade.

A third aspect of the disclosure provides a turbine bucket, including: a shank; a multi-wall blade coupled to the shank; and a cooling system disposed within the multi-wall blade, the cooling system including: a first arcuate turn for redirecting a first flow of gas flowing through a first channel into a central plenum of the blade; a second arcuate turn for redirecting a second flow of gas flowing through a second channel into the central plenum of the blade, the first flow of gas and the second flow of gas combining in the central plenum; wherein the first and second arcuate turns reduce impingement of the first flow of gas and the second flow of gas in the central plenum.

The illustrative aspects of the present disclosure solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawing that depicts various embodiments of the disclosure.

FIG. 1 shows a perspective view of a turbine bucket including a blade, according to embodiments.

FIG. 2 is a partial cross-sectional view of the blade of FIG. 1, taken along line 2-2 in FIG. 1, according to embodiments.

FIG. 3 depicts a pressure loss reducing structure with shaped return channels, according to embodiments.

FIG. 4 is a partial cross-sectional view of the blade of FIG. 1 depicting a pressure loss reducing structure with shaped return channels, according to embodiments.

FIG. 5 depicts a pressure loss reducing structure with turning vanes, according to embodiments.

FIG. 6 depicts a pressure loss reducing structure with turning vanes, according to embodiments.

FIG. 7 is a partial cross-sectional view of the blade of FIG. 1 depicting a pressure loss reducing structure with turning vanes in the return channels, according to embodiments.

It is noted that the drawing of the disclosure is not to scale. The drawing is intended to depict only typical aspects of the disclosure, and therefore should not be considered as limiting the scope of the disclosure. In the drawing, like numbering represents like elements between the drawings.

### DETAILED DESCRIPTION OF THE INVENTION

As indicated above, the disclosure relates generally to turbine systems, and more particularly, to reducing pressure loss in a multi-wall turbine blade cooling circuit.

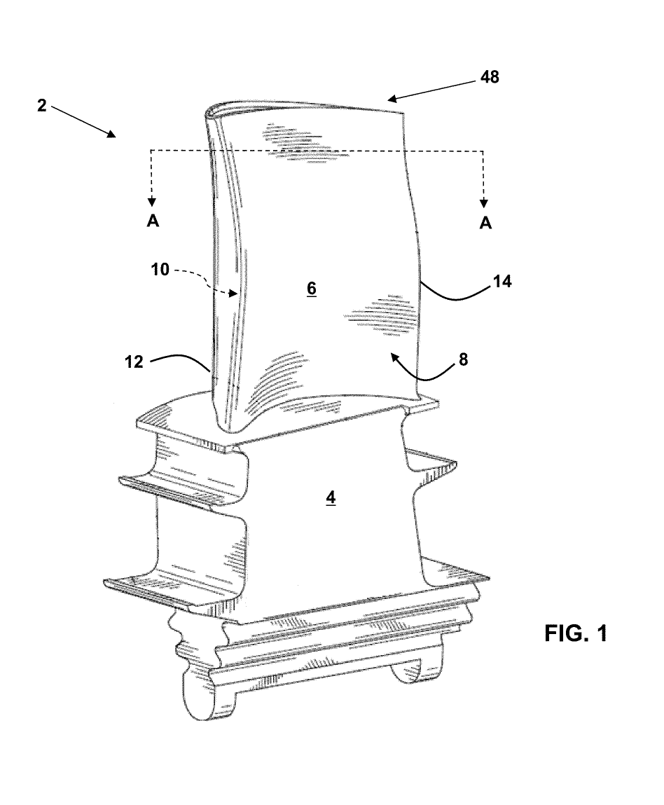

Turning to FIG. 1, a perspective view of a turbine bucket 2 is shown. The turbine bucket 2 includes a shank 4 and a blade 6 (e.g., a multi-wall blade) coupled to and extending radially outward from the shank 4. The blade 6 includes a pressure side 8 and an opposed suction side 10. The blade 6 further includes a leading edge 12 between the pressure side 8 and the suction side 10, as well as a trailing edge 14 between the pressure side 8 and the suction side 10 on a side opposing the leading edge 12.

The shank 4 and blade 6 may each be formed of one or more metals (e.g., steel, alloys of steel, etc.) and can be formed (e.g., cast, forged or otherwise machined) according to conventional approaches. The shank 4 and blade 6 may be integrally formed (e.g., cast, forged, three-dimensionally printed, etc.), or may be formed as separate components which are subsequently joined (e.g., via welding, brazing, bonding or other coupling mechanism).

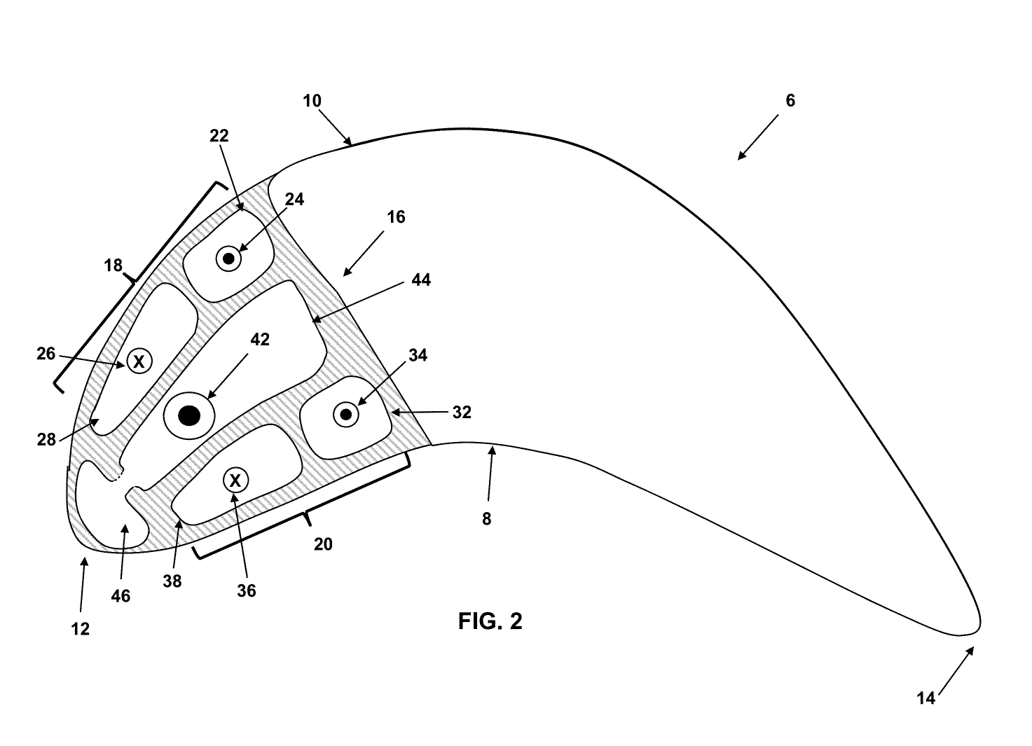

FIG. 2 is a partial cross-sectional view of the blade 6 taken along line 2-2 of FIG. 1, depicting a cooling arrangement 16 including a plurality of cooling circuits, according to embodiments. In this example, the cooling arrangement 16 includes an internal 2-pass serpentine suction side (SS) cooling circuit 18 on the suction side 10 of the blade 6 as well as an internal 2-pass serpentine pressure side (PS) cooling circuit 20 on the pressure side 8 of the blade 6. Although described in terms of a 2-pass serpentine cooling circuit, it should be apparent to those skilled in the art that the pressure loss reducing structures of the present disclosure (described below) may be used in conjunction with other types of serpentine (e.g., 3-pass, 4-pass, etc.) and/or non-serpentine cooling circuits in which “spent” cooling air from a plurality of flow channels is collected for redistribution to other areas of the blade 6, shank 4, and/or other portions of the bucket 2 for cooling purposes. Further, the pressure loss reducing structures may be used in other sections of the blade 6, shank 4, and/or other portions of the bucket 2 where there is a need for gathering a plurality of gas flows into a single gas flow for redistribution.

The SS cooling circuit 18 includes a feed channel 22 for directing a flow of cooling gas 24 (e.g., air) radially outward toward a tip area 48 (FIG. 1) of the blade 6 along the suction side 10 of the blade 6. In FIG. 2, the flow of cooling gas 24 is depicted as flowing out of the page. After passing through a turn (not shown), a flow of “spent” cooling gas 26 is directed back towards the shank 4 of the blade 6 through a return channel 28. In FIG. 2, the flow of cooling gas 26 is depicted as flowing into of the page.

The PS cooling circuit 20 includes a feed channel 32 for directing a flow of cooling gas 34 (e.g., air) radially outward toward the tip area 48 (FIG. 1) of the blade 6 along the pressure side 8 of the blade 6. After passing through a turn (not shown), a flow of “spent” cooling gas 36 is directed back towards the shank 4 of the blade 6 through a return channel 38. In FIG. 2, the flow of cooling gas 34 is depicted as flowing out of the page, while the flow of cooling gas 36 is depicted as flowing into of the page.

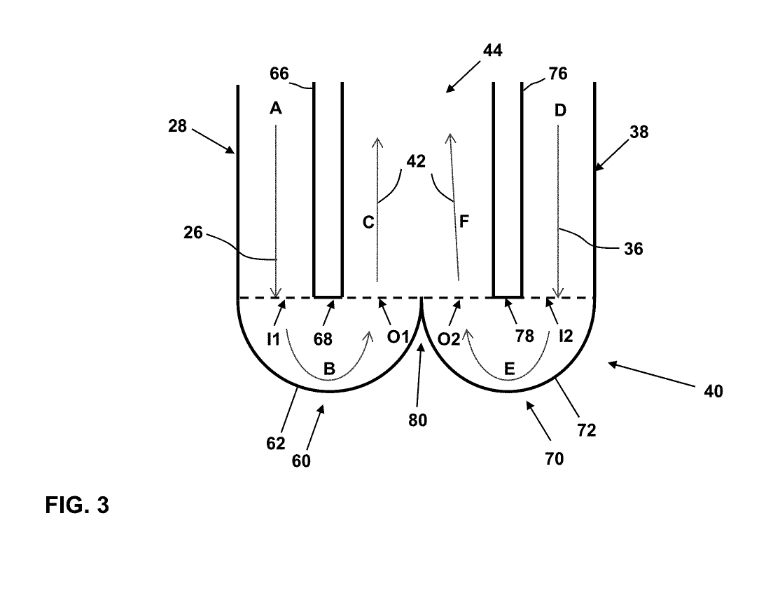

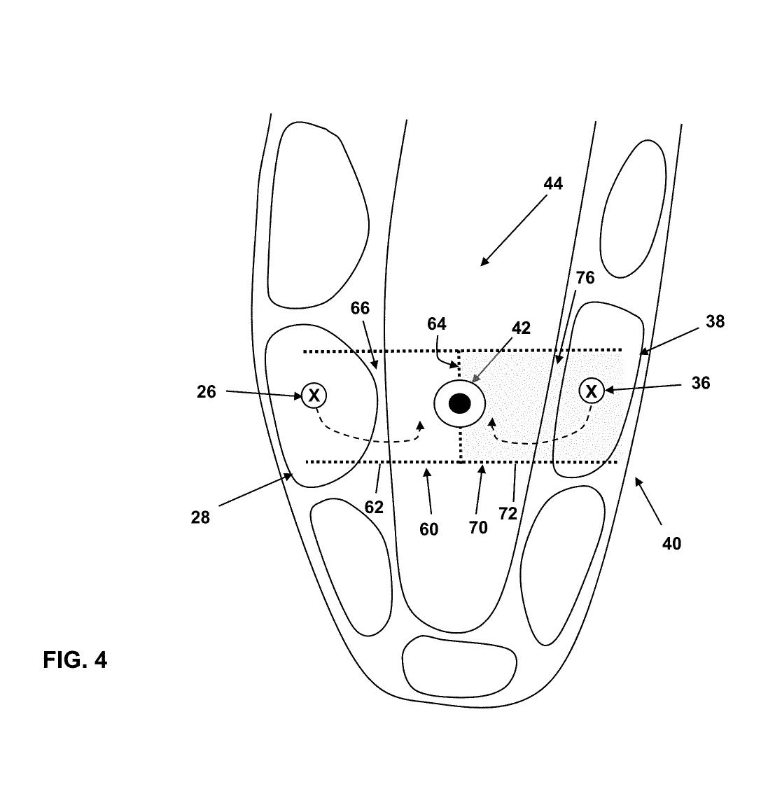

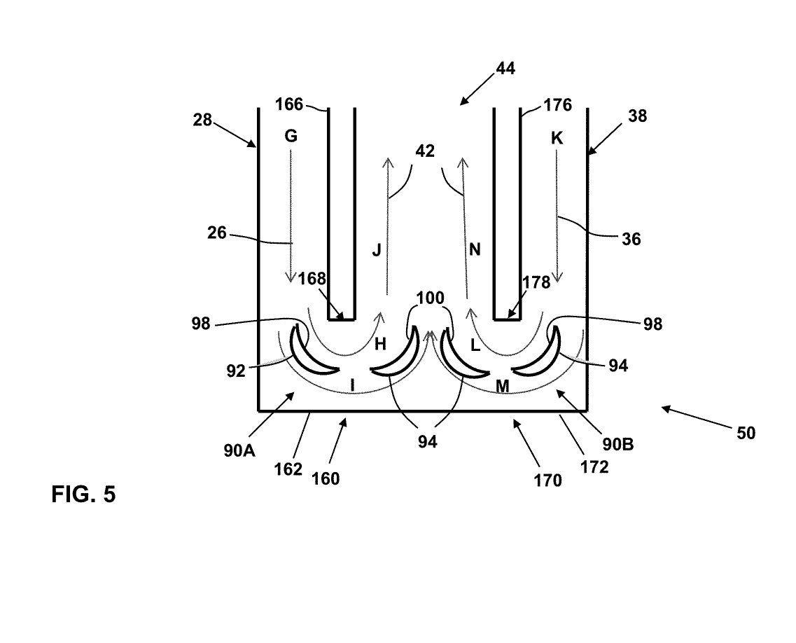

According to embodiments, referring to FIGS. 3 and 5, together with FIG. 2, a pressure loss reducing structure 40 (FIG. 3), 50 (FIG. 5) is provided for combining the flow of cooling gas 26 flowing through the return channel 28 of the SS cooling circuit 18 with the flow of cooling gas 36 flowing through the return channel 38 of the PS cooling circuit 20, to form a single, combined flow of cooling gas 42 within a central plenum 44. This may be achieved with reduced pressure loss by preventing impingement of the flows of cooling gas 26, 36 as the flows enter the central plenum 44. The pressure loss reducing structure 40 is configured to turn the flows of cooling gas 26, 36 before the flows of cooling gas 26, 36 enter the central plenum 44. This may be achieved, for example, by shaping (FIG. 3) the return channels 28, 38 and/or by using turning vanes (FIG. 4) in the return channels 28, 38, such that the flows of cooling gas 26, 36 are substantially parallel to one another when combined in the central plenum 44. Advantageously, the redirected flows of cooling gas 26, 36 flow into the central plenum 44 with reduced impingement and associated pressure loss.

In the blade 6, the flow of cooling gas 42 passes radially outward through the central plenum 44 (out of the page in FIG. 2). From the central plenum 44, the flow of cooling gas 42 may be redistributed, for example, to a leading edge cavity 46 located in the leading edge 12 of the blade 6 to provide impingement cooling. Alternatively, or in addition, the flow of cooling gas 42 may be redistributed to the tip area 48 (FIG. 1) of the blade 6. The flow of cooling gas 42 may also be provided to other locations within the blade 6, shank 4, and/or other portions of the bucket 2 for purposes of convention cooling. Still further, the flow of cooling gas 42 may be used to provide film cooling of the exterior surfaces of the blade 6. Depending on the location of the pressure loss reducing structure 40, 50 in the blade 6, the flow of cooling gas 42 may be also be redistributed, for example, to cooling channels/circuits at the trailing edge 14 of the blade 6. Any number of pressure loss reducing structures 40, 50 may be employed within the blade 6.

A first embodiment of a pressure loss reducing structure 40 is depicted in FIG. 3. As shown in FIG. 3, the flow of cooling gas 26 flowing through the return channel 28 of the SS cooling circuit 18 flows through the return channel 28 in a first direction (arrow A) to a first arcuate turn 60 of the pressure loss reducing structure 40, which has an arcuate end wall 62. The flow of cooling gas 26 flows from the return channel 28 into the first arcuate turn 60 through an inlet I1. The flow of cooling gas 26 is redirected (arrow B) by the arcuate end wall 62 and a peaked junction 80 formed by the distal ends of the arcuate end wall 62 and an arcuate end wall 72 of a second arcuate turn 70 (described below) toward and into (arrow C) the central plenum 44 through an outlet O1, forming a portion of the flow of cooling gas 42. The return channel 28 and the central plenum 44 are separated by a rib 66. As shown in FIG. 3, the flow of cooling gas 26 flows around an end section 68 of the rib 66.

Also depicted in FIG. 3 is a second arcuate turn 70 of the pressure loss reducing structure 40. The flow of cooling gas 36 flowing through the return channel 38 of the PS cooling circuit 20 flows through the return channel 38 in a first direction (arrow D) to the second arcuate turn 70 of the pressure loss reducing structure 40, which has an arcuate end wall 72. The flow of cooling gas 36 flows from the return channel 38 into the second arcuate turn 70 through an inlet 12. The flow of cooling gas 36 is redirected (arrow E) toward and into (arrow F) the central plenum 44 by the arcuate end wall 72 and the peaked junction 80 through an outlet O2, forming another portion of the flow of cooling gas 42. The return channel 38 and the central plenum 44 are separated by a rib 76. The flow of cooling gas 36 flows around an end section 78 of the rib 76.

In embodiments, the arcuate end walls 62, 72 and the peaked junction 80 formed by the distal ends of the first and second arcuate turns 60, 70 prevent impingement of the flows of cooling gas 26, 36 and direct the flows of cooling gas 26, 36 upward toward and into the central plenum 44. In the central plenum 44, the flows of cooling gas 26, 36 combine to produce the flow of cooling gas 42.

The arcuate end walls 62, 72 of the first and second arcuate turns 60, 70 may be substantially semicircular. Thus, the flows of cooling gas 26, 36 may be rotated up to about 180° as the flows of cooling gas 26, 36 pass around the end sections 68, 78 of the ribs 66, 76. Other suitable configurations of the first and second end walls 62, 72 of the arcuate turns 60, 70 may also be used in various implementations of the pressure loss reducing structure 40.

FIG. 4 is a partial cross-sectional view of the blade of FIG. 1 depicting the pressure loss reducing structure 40. As shown, the flow of cooling gas 26 flows through the return channel 28 in a first direction (into the page in FIG. 4) to a first arcuate turn 60 of the pressure loss reducing structure 40. At the first arcuate turn 60, the flow of cooling gas 26 is redirected in a second direction (out of the page in FIG. 4) by the arcuate end wall 62 and peaked junction 80 and flows into the central plenum 44, forming a portion of the flow of cooling gas 42. The return channel 28 and the central plenum 44 are separated by the rib 66.

The flow of cooling gas 36 flows through the return channel 38 in a first direction (into the page in FIG. 4) to the second arcuate turn 70 of the pressure loss reducing structure 40. At the second turn 70, the flow of cooling gas 36 is redirected in a second direction (out of the page in FIG. 4) by the arcuate end wall 72 and peaked junction 80 and flows into the central plenum 44, forming another portion of the flow of cooling gas 42. The return channel 38 and the central plenum 44 are separated by the rib 76.

Another embodiment of a pressure loss reducing structure 50 is depicted in FIG. 5. Unlike the previously described pressure loss reducing structure 40, the pressure loss reducing structure 50 includes a plurality of sets 90A, 90B of turning vanes 92, 94, which are configured to redirect the flows of cooling gas 26, 36 into the central plenum 44 with reduced impingement and associated pressure loss.

As shown, the flow of cooling gas 26 flows through the return channel 28 in a first direction (arrow G) to a first arcuate turn 160 of the pressure loss reducing structure 50. In this embodiment, the arcuate configuration of the first arcuate turn 160 is provided by the set 90A of turning vanes 92, 94, rather than shape of the turn itself (FIG. 3) as in the above-described embodiment. At the first arcuate turn 160, the flow of cooling gas 26 is redirected (arrows H, I) by the set 90A of turning vanes 92, 94 and an end wall 162. The redirected flow of cooling gas 26 flows toward and into (arrow J) the central plenum 44, forming a portion of the flow of cooling gas 42. The return channel 28 and the central plenum 44 are separated by a rib 166. As shown in FIG. 5, the flow of cooling gas 26 flows around an end section 168 of the rib 166.

Also depicted in FIG. 5 is a second arcuate turn 170 of the pressure loss reducing structure 50. The flow of cooling gas 36 flows through the return channel 38 in a first direction (arrow K) to the second arcuate turn 170 of the pressure loss reducing structure 50. At the second arcuate turn 170, the flow of cooling gas 36 is redirected (arrows L, M) by the set 90B of turning vanes 92, 94 and an end wall 172. The end wall 172 may be substantially coplanar with the end wall 162. Similar to the first arcuate turn 160, the arcuate configuration of the second arcuate turn 170 is provided by the set 90B of turning vanes 92, 94 rather than shape of the turn itself (FIG. 3) as in the above-described embodiment. The redirected flow of cooling gas 36 subsequently flows toward and into (arrow N) into the central plenum 44, forming another portion of the flow of cooling gas 42. The return channel 38 and the central plenum 44 are separated by a rib 176. The flow of cooling gas 36 flows around an end section 178 of the rib 176.

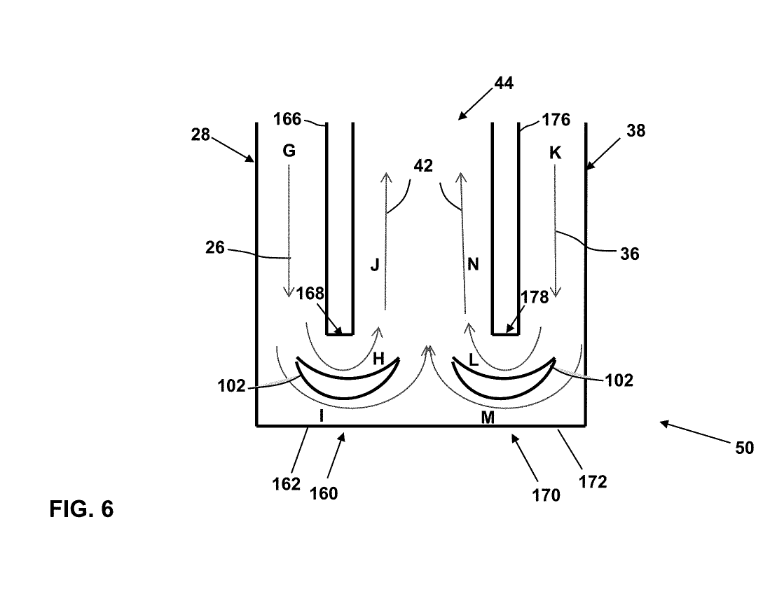

In embodiments, the turning vanes 92, 94 have an arcuate configuration. Although described as including two turning vanes 92, 94, each set of turning vanes 90A, 90B may include any number of suitably arranged turning vanes. For instance, as shown in FIG. 6, a single turning vane 102 may be provided in the first and second arcuate turns 160, 170. More than two turning vanes may also be used.

As shown in FIG. 5, in each of the sets 90A, 90B of turning vanes 92, 94, a concave face 98 of the turning vane 92 faces a concave face 100 of the turning vane 94, thereby forming arcuate paths (H, I),(L, M) in the first and second arcuate turns 160, 170. The turning vanes 92, 94 in each set 90A, 90B are configured such that the flow direction of the flows of cooling gas 26, 36 may be rotated up to about 180° as the flows of cooling gas 26, 36 pass around the end sections 168, 178 of the ribs 166, 176. The turning vanes may be positioned away from the end walls 168, 178 of the first and second arcuate turns 160, 170. To this extent, the flow of cooling gas 26 may flow around both sides of the turning vanes 92, 94 of set 90A (as represented by arrows H, I), while the flow of cooling gas 36 may flow around both sides of the turning vanes 92, 94 of set 90B (as represented by arrows L, M).

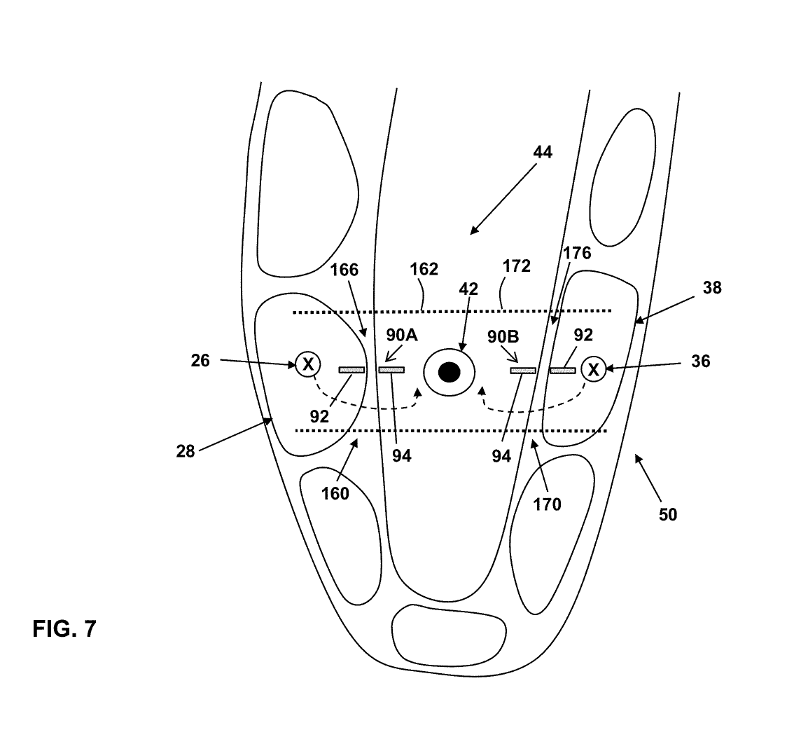

FIG. 7 is a partial cross-sectional view of the blade of FIG. 1 depicting the pressure loss reducing structure 50. As shown, the flow of cooling gas 26 flows through the return channel 28 in a first direction (into the page in FIG. 7) to the first arcuate turn 160 of the pressure loss reducing structure 40. At the first arcuate turn 160, the flow of cooling gas 26 is redirected in a second direction into the central plenum 44 (out of the page in FIG. 7) by the turning vanes 92, 94 of set 90A and the end wall 162, forming a portion of the flow of cooling gas 42. The return channel 28 and the central plenum 44 are separated by the rib 166.

The flow of cooling gas 36 flows through the return channel 38 in a first direction (into the page in FIG. 7) to the second arcuate turn 170 of the pressure loss reducing structure 40. At the second arcuate turn 170, the flow of cooling gas 36 is redirected in a second direction into the central plenum 44 (out of the page in FIG. 7) by the turning vanes 92, 94 of set 90B and the end wall 172, forming a portion of the flow of cooling gas 42. The return channel 38 and the central plenum 44 are separated by the rib 176.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

When an element or layer is referred to as being “on”, “engaged to”, “connected to” or “coupled to” another element, it may be directly on, engaged, connected or coupled to the other element, or intervening elements may be present. In contrast, when an element is referred to as being “directly on,” “directly engaged to”, “directly connected to” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine blade cooling system, comprising:
a first arcuate turn for redirecting a first flow of gas flowing through a first channel of a turbine blade into a central plenum of the turbine blade; and
a second arcuate turn for redirecting a second flow of gas flowing through a second channel of the turbine blade into the central plenum of the turbine blade,
wherein the first and second arcuate turns reduce impingement of the first flow of gas and the second flow of gas in the central plenum of the turbine blade.

2. The turbine blade cooling system according to claim 1, wherein the turbine blade comprises a multi-wall turbine blade.

3. The turbine blade cooling system according to claim 1, wherein the reduced impingement decreases a pressure loss in the central plenum.

4. The turbine blade cooling system according to claim 1, further comprising a peaked junction formed by adjacent distal ends of an end wall of the first arcuate turn and an end wall of the second arcuate turn.

5. The turbine blade cooling system according to claim 1, wherein the first arcuate turn redirects the first flow of gas about 180°, and wherein the second arcuate turn redirects the second flow of gas about 180°.

6. The turbine blade cooling system according to claim 1, wherein the first arcuate turn and the second arcuate turn are semicircular.

7. The turbine blade cooling system according to claim 1, wherein the first arcuate turn and the second arcuate turn each comprise a set of turning vanes.

8. The turbine blade cooling system according to claim 7, wherein the each turning vane has an arcuate shape.

9. The turbine blade cooling system according to claim 8, wherein in each set of turning vanes, a concave face of a first turning vane faces a concave face of a second turning vane.

10. The turbine blade cooling system according to claim 9, wherein the turning vanes are spaced apart from end walls of the first and second arcuate turns.

11. The turbine blade cooling system according to claim 10, wherein the end walls of the first and second arcuate turns are substantially coplanar.

12. The turbine blade cooling system according to claim 1, wherein the first channel extends along a suction side of the blade, and wherein the second channel extends along a pressure side of the blade.

13. A turbine blade, comprising:
a cooling system disposed within the turbine blade, the cooling system including:
a first arcuate turn for redirecting a first flow of gas flowing through a first channel of the turbine blade into a central plenum of the turbine blade; and
a second arcuate turn for redirecting a second flow of gas flowing through a second channel of the turbine blade into the central plenum of the turbine blade;
wherein the first and second arcuate turns reduce impingement of the first flow of gas and the second flow of gas in the central plenum of the turbine blade.

14. The turbine blade according to claim 13, wherein the turbine blade comprises a multi-wall turbine blade.

15. The turbine blade according to claim 13, wherein the first channel extends along a suction side of the blade, and wherein the second channel extends along a pressure side of the blade.

16. The turbine blade according to claim 13, further comprising a peaked junction formed by adjacent distal ends of an end wall of the first arcuate turn and an end wall of the second arcuate turn.

17. The turbine blade according to claim 13, wherein the first arcuate turn and the second arcuate turn each comprise a set of arcuate turning vanes.

18. The turbine blade according to claim 17, wherein the first turn includes an end wall and the second turn including an end wall, wherein the end wall of the first turn is substantially coplanar with the end wall of the second turn, and wherein the turning vanes are spaced apart from the end walls of the first and second arcuate turns.

19. A turbine bucket, comprising:
a shank;
a multi-wall blade coupled to the shank; and
a cooling system disposed within the multi-wall blade, the cooling system including:
a first arcuate turn for redirecting a first flow of gas flowing through a first channel into a central plenum of the blade;
a second arcuate turn for redirecting a second flow of gas flowing through a second channel into the central plenum of the blade, the first flow of gas and the second flow of gas combining in the central plenum;
wherein the first and second arcuate turns reduce impingement of the first flow of gas and the second flow of gas in the central plenum.

20. The turbine bucket according to claim 19, wherein the combined flow of gas in the central plenum is provided by the cooling system to other areas of the blade or shank for cooling.
